(19) United States
(12) Patent Application Publication
(10) Pub. No.: US 2026/0044573 A1
(43) Pub. Date: Feb. 12, 2026

(54) HARDWARE ACCELERATOR WITH GENERALIZED MATRIX-VECTOR MULTIPLICATION AND POST-PROCESSING CIRCUITS

(71) Applicant: Microsoft Technology Licensing, LLC, Redmond, WA (US)

(72) Inventors: Mrinal DEO, Sammamish, WA (US); Lincoln Ray WALLER, Cary, NC (US); Xiaoling XU, Cupertino, CA (US)

(73) Assignee: Microsoft Technology Licensing, LLC, Redmond, WA (US)

(21) Appl. No.: 18/799,849

(22) Filed: Aug. 9, 2024

(51) Int. Cl. G06F 17/16

(52) U.S. Cl. CPC G06F 17/16

(57) ABSTRACT

A computing device including a hardware accelerator. The hardware accelerator includes a generalized matrix-vector multiplication (GEMV) circuit configured to compute a product vector over a plurality of streaming iterations. At each of the streaming iterations, the GEMV circuit receives an input vector element and an input matrix row. The GEMV circuit multiplies the input vector element by input matrix elements included in the input matrix row to obtain an intermediate product row. The GEMV circuit adds the intermediate product row to a current-iteration row sum. The product vector is equal to the current-iteration row sum computed in a final streaming iteration. The GEMV circuit transmits the product vector as a streaming output to a post-processing circuit included in the hardware accelerator. The post-processing circuit performs a vector processing operation on the product vector to compute vector processing result, and outputs the vector processing result.

### BACKGROUND

As the use of machine learning has grown in recent years, specialized hardware accelerators have been developed to perform computations that frequently occur in machine learning settings. Such hardware accelerators are configured to perform those operations more efficiently than they would be performed on conventional processing devices such as central processing units (CPUs). For example, the specialized hardware accelerators may perform specific operations more quickly and with lower energy consumption.

Hardware accelerators that perform generalized matrix-matrix multiplication (GEMM) are one category of hardware accelerators that have been developed for use in machine learning applications. GEMM operations are widely used at machine learning models during both training and inferencing. By performing GEMM operations at specialized hardware accelerators, increased parallelization may be achieved, which may accordingly reduce the latency and energy consumption associated with GEMM operations.

### SUMMARY

According to one aspect of the present disclosure, a computing device is provided, including a hardware accelerator. The hardware accelerator includes a generalized matrix-vector multiplication (GEMV) circuit configured to compute a product vector over a plurality of streaming iterations. At each of the streaming iterations, the GEMV circuit is configured to receive an input vector element and an input matrix row as streaming inputs. The GEMV circuit is further configured to multiply the input vector element by each of a plurality of input matrix elements included in the input matrix row to obtain an intermediate product row. The GEMV circuit is further configured to add the intermediate product row to a current-iteration row sum. The product vector is equal to the current-iteration row sum computed in a final streaming iteration of the plurality of streaming iterations. The GEMV circuit is further configured to transmit the product vector as a streaming output to a post-processing circuit included in the hardware accelerator. The post-processing circuit is configured to perform a vector processing operation on the product vector to compute vector processing result. The post-processing circuit is further configured to output the vector processing result.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing device that includes one or more processing devices, one or more memory devices, and a hardware accelerator, according to one example embodiment.

FIG. 2 schematically shows a generalized matrix-vector multiplication (GEMV) circuit included in the hardware accelerator, according to the example of FIG. 1.

FIG. 3 schematically shows a post-processing circuit included in the hardware accelerator, according to the example of FIG. 1.

FIG. 4 schematically shows an example transformer block included in a neural network, according to the example of FIG. 1.

FIG. 5A schematically shows a mixture-of-experts (MoE) model including at least one MoE layer, according to the example of FIG. 1.

FIG. 5B schematically shows an expert included in the MoE layer when a generalized matrix-matrix multiplication (GEMM) operation is performed at a feed-forward block, according to the example of FIG. 5A.

FIG. 6A shows a flowchart of a method performed at a hardware accelerator included in a computing device to compute a vector processing result, according to the example of FIG. 1.

FIGS. 6B-6C show additional steps of the method of FIG. 6A that may be performed in some examples.

FIG. 7 shows a schematic view of an example computing environment in which the computing device of FIG. 1 may be instantiated.

### DETAILED DESCRIPTION

Generalized matrix-vector multiplication (GEMV) is another type of operation that frequently occurs in machine learning settings. In existing hardware accelerators that have been developed for machine learning applications, GEMV operations are typically performed using the same processing circuits used for GEMM operations on larger matrices. When a GEMM circuit is used to perform a GEMV operation, the input vector and input matrix are loaded into input buffers of the GEMM circuit prior to processing. The input buffer that stores the input vector is padded with zeroes to account for the lower dimensionality of the input vector (which has a height or width of 1) relative to the full size of the input buffer.

Performing a GEMV operation at a specialized GEMM circuit is frequently inefficient. First, loading the input vector and the input matrix into the input buffers has associated latency. The hardware accelerator incurs additional latency when reading a result of the GEMV operation from an output buffer. In addition, unnecessary computations are performed to pad the input buffer with zeroes and process those zero-valued matrix elements in a GEMM operation.

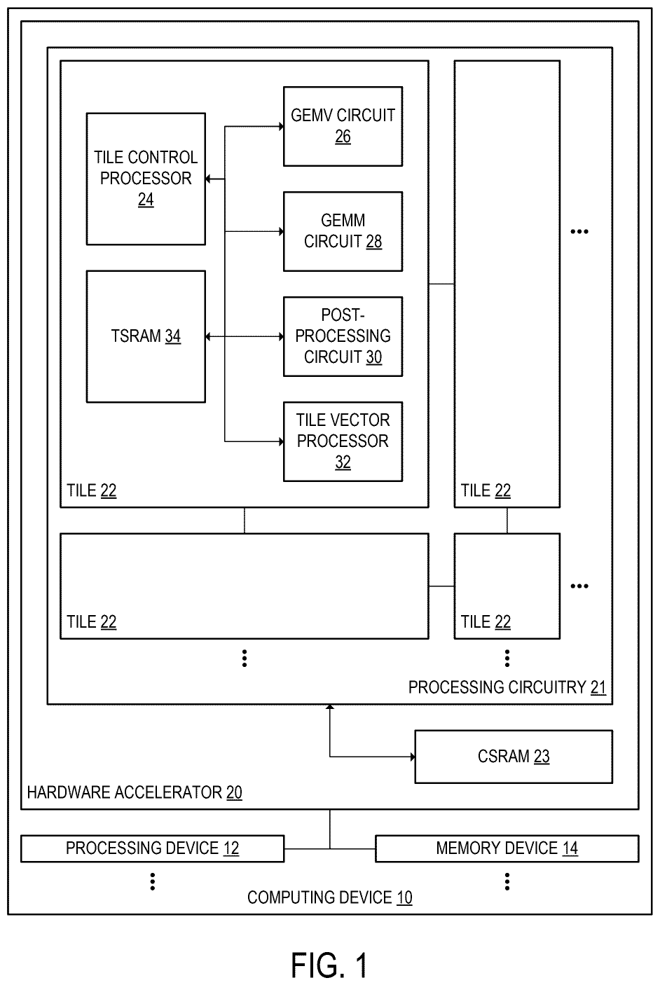

In order to address the above inefficiencies associated with performing a GEMV operation and a GEMM accelerator, a computing device 10 is provided according to the example of FIG. 1. The computing device 10 shown in the example of FIG. 1 includes one or more processing devices 12, one or more memory devices 14, and a hardware accelerator 20. The one or more processing devices 12 may include, for example, one or more CPUs, one or more GPUs, and/or one or more other hardware accelerators. The one or more memory devices 14 may include one or more volatile memory devices and/or one or more non-volatile storage devices. In the example of FIG. 1, the hardware accelerator 20 is a neural processing unit (NPU).

In some examples, the components of the computing device 10 shown in FIG. 1 may have a system-on-a-chip (SoC) configuration in which the hardware accelerator 20, one or more processing devices 12, and one or more memory devices 14 are provided in an integrated computing device component. In other examples, the components of the computing device 10 shown in FIG. 1 may be provided as separate components of a physical computing device. Components of the computing device 10 may also be distributed across a plurality of interlinked physical computing devices in some examples.

In the example of FIG. 1, the hardware accelerator 20 includes processing circuitry 21 structured as an array of tiles 22. For example, as shown in FIG. 1, the tiles 22 may form a systolic array. The hardware accelerator 20 further includes cluster static random access memory (CSRAM) 23 configured to store input and output data of the processing circuitry 21.

The example of FIG. 1 further shows components included in a tile 22. The example tile 22 includes a tile control processor (TCP) 24 that is configured to transmit control instructions to other components of the tile 22. Those components, in the example of FIG. 1, include a GEMV circuit 26, a GEMM circuit 28, a post-processing circuit 30, and a tile vector processor 32. The functionality of these components is discussed in further detail below. In addition, the tile 22 includes tile static random access memory (TSRAM) 34 configured to store tile-level data.

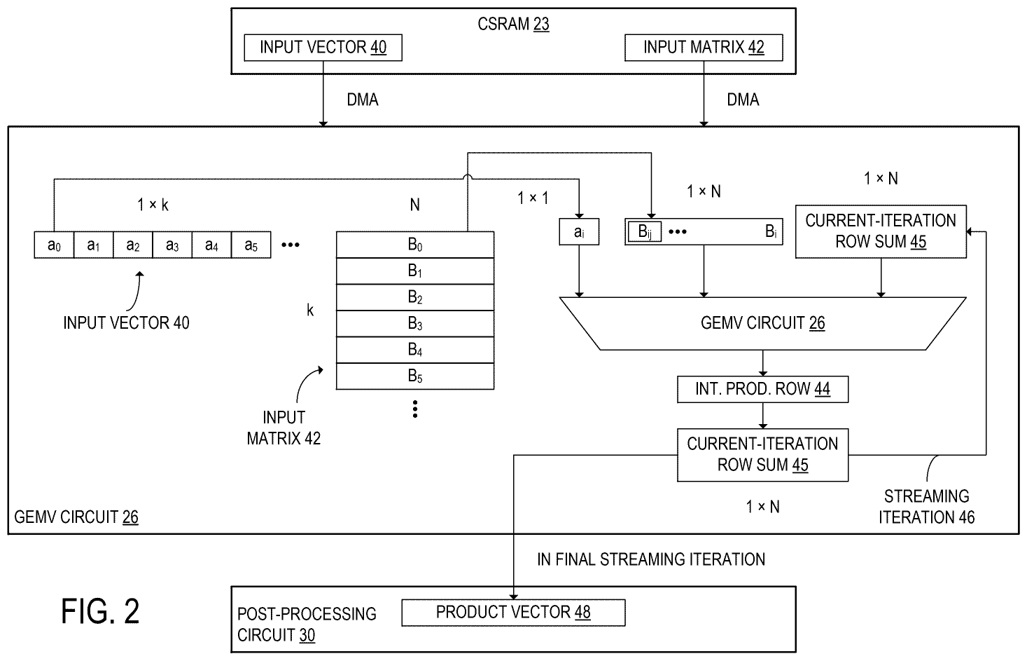

The GEMV circuit 26 is a logic circuit specialized for performing GEMV operations more efficiently than the GEMM circuit 28 and the other logic circuits included in the computing device 10. FIG. 2 schematically shows the GEMV circuit 26 in further detail when a GEMV operation is performed. As shown in FIG. 2, the GEMV circuit 26 is configured to compute a product vector 48 over a plurality of streaming iterations 46. Over the plurality of streaming iterations 46, an input vector 40 and an input matrix 42 are incrementally read into the GEMV circuit 26 as inputs to the GEMV operation.

In machine learning applications of the GEMV circuit 26, the input vector 40 and the input matrix 42 may respectively be a query vector Q and a key matrix KT that are multiplied during a self-attention computation, as discussed in further detail below. In such examples, the input vector 40 may indicate a token within an embedding space of a neural network at which the self-attention computation is performed. For example, the token indicated by the input vector 40 may be a text token in examples in which the neural network is a language model. Columns of the input matrix 42 may also correspond to tokens.

The input vector 40 is size 1×k and the input matrix 42 is size k×N. At each of the streaming iterations 46, the GEMV circuit 26 is configured to receive an input vector element a; and an input matrix row Bᵢ as streaming inputs. The input vector elements aᵢ are each size 1×1 and the input matrix rows are each size 1×N.

In some examples, the GEMV circuit 26 may be configured to receive the input vector elements a; and the input matrix rows Bᵢ via direct memory access (DMA). In such examples, the GEMV circuit 26 may be configured to receive the input vector elements a; and the input matrix rows Bᵢ from the CSRAM 23. The hardware accelerator 20 may accordingly avoid having to read the input vector 40 and the input matrix 42 into the TSRAM 34 in their entirety prior to processing. Streaming the inputs to the GEMV circuit 26 may therefore increase the efficiency with which the hardware accelerator 20 performs GEMV operations by increasing the utilization rate of the GEMV circuit 26.

The GEMV circuit 26 is further configured to multiply the input vector element aᵢ by each of a plurality of input matrix elements Bᵢⱼ included in the input matrix row Bᵢ to obtain an intermediate product row 44. The intermediate product rows 44 computed at respective streaming iterations 46 are each size 1×N. The GEMV circuit 26 is further configured to add the intermediate product row 44 to a current-iteration row sum 45. The product vector 48 computed as the output of the GEMV operation is equal to the current-iteration row sum 45 computed in a final streaming iteration 46 of the plurality of streaming iterations 46. Thus, the product vector 48 is computed as a sum of the intermediate product rows 44.

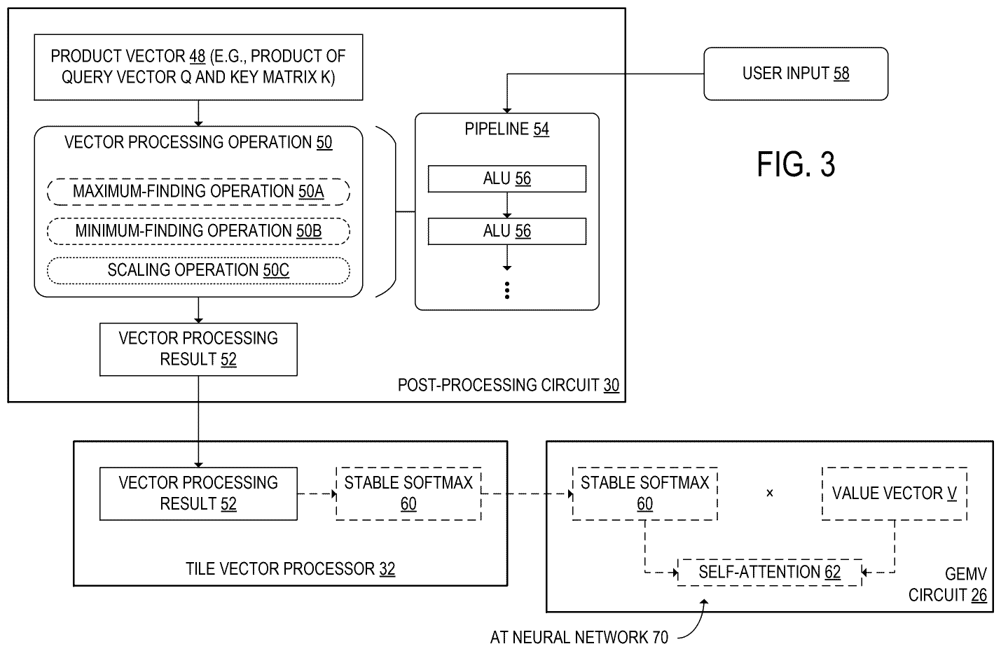

The GEMV circuit 26 is further configured to transmit the product vector 48 as a streaming output to the post-processing circuit 30. FIG. 3 schematically shows the post-processing circuit 30 in additional detail when the post-processing circuit 30 receives the product vector 48, according to one example. The post-processing circuit 30 is configured to perform a vector processing operation 50 on the product vector 48 to compute vector processing result 52. The post-processing circuit 30 is further configured to output the vector processing result 52. Thus, at the post-processing circuit 30, the hardware accelerator 20 is configured to post-process the product vector 48 computed in the GEMV operation. In some examples, the post-processing circuit 30 may also be used to pre-process an input to the GEMV operation.

The vector processing operation 50 performed at the post-processing circuit 30 is a computation that takes a vector-valued input. The output of the vector processing operation 50 may, for example, be a scalar or a vector. In some examples, the vector processing operation 50 may be a maximum-finding operation 50A, a minimum-finding operation 50B, or a scaling operation 50C. In addition to the vector-valued input, the vector processing operation 50 may also receive a scalar-valued input, such as in examples in which the vector processing operation 50 is the scaling operation 50C.

According to the example of FIG. 3, the post-processing circuit 30 includes a pipeline 54 of arithmetic logic units (ALUs) 56. The ALUs 56 are circuits that implement hardware-level logic gates. The pipeline 54 is reprogrammable to select the specific vector processing operation 50 performed at the post-processing circuit 30. In some examples, the pipeline 54 of ALUs 56 may be specified via user input 58. A user may accordingly reprogram the post-processing circuit 30 to define the post-processing operation the post-processing circuit 30 performs.

As depicted in FIG. 3, a maximum-finding operation 50A may be performed at the post-processing circuit 30 in examples in which the GEMV circuit 26 is configured to compute a self-attention 62 at a neural network 70. The neural network 70 may be a transformer network. The self-attention 62 may be computed as follows:

$$Attention ( Q , K , V ) = softmax ( \frac{Q {K}^{T}}{\sqrt{{d}_{k}}} ) V$$

In the above equation, Q is the query vector, K is the key matrix, V is a value vector, and dₖ is the dimensionality of the key matrix. In some examples, the constant factor of

$$\frac{1}{\sqrt{{d}_{k}}}$$

may be applied to the query vector Q or the key matrix K during pre-processing that occurs before the GEMV operation. In other examples, the scale factor of

$$\frac{1}{\sqrt{{d}_{k}}}$$

may be applied to the product vector 48 the post-processing circuit 30. The value vector V may be a vector of a plurality of tokens.

In examples in which a self-attention 62 is computed, the maximum-finding operation 50A may be included in a Stable SoftMax operation performed during the self-attention computation. The SoftMax function is defined as:

$$softmax ( {Z}_{i} ) = \frac{{e}^{{Z}_{i}}}{{\sum }_{j = 1}^{N} {e}^{{Z}_{j}}}$$

Stable SoftMax is instead computed as follows:

$$softmax ( {Z}_{i} ) = \frac{{e}^{{Z}_{i} - max ( Z )}}{{\sum }_{j = 1}^{N} {e}^{{Z}_{j} - max ( Z )}}$$

In the above equations, Z is a vector, Zᵢ is the ith element of Z, and N is the total number of elements in Z. The computation of the Stable Softmax 60 differs from typical SoftMax computation in that the maximum element of Z is subtracted from the vector elements Zᵢ and Zⱼ that are included in the exponents. This scaling allows the use of smaller buffers to store the results of exponentiation. However, since the same scale factor of e^{-max(z)} is applied to the numerator and to each term of the denominator, Stable SoftMax returns the same outputs as SoftMax. The Stable SoftMax 60 may then be multiplied by the value vector V to obtain the self-attention 62.

FIG. 3 further shows an example data path between different areas of the hardware accelerator 20 during self-attention computation. In the example of FIG. 3, the hardware accelerator 20 is configured to identify the maximum element of the product vector 48 at the post-processing circuit 30 as the vector processing result 52 and is further configured to transmit the maximum element to the TVP 32. The TVP 32 is configured to compute the Stable SoftMax 60 of the product vector 48 using the maximum element. The TVP 32 is further configured to transmit the Stable SoftMax 60 to the GEMV circuit 26. The GEMV circuit 26 is configured to multiply the Stable SoftMax 60 by the value vector V to compute the self-attention 62 and is further configured to output the self-attention 62.

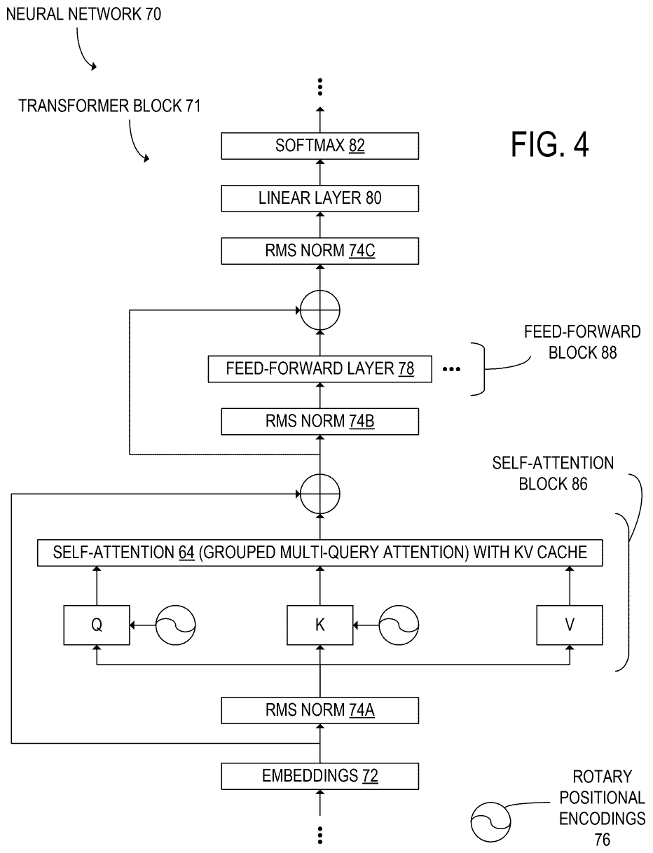

FIG. 4 schematically shows an example transformer block 71 that may be included in the neural network 70. FIG. 4 shows the example transformer block 71 during a forward pass. The transformer block 71 is configured to receive embeddings 72 as input. The embeddings 72 are expressed as a vector in an embedding space. The computing device 10 is further configured to compute a root mean squared (RMS) norm 74A of the embeddings 72.

FIG. 4 shows a self-attention block 86 included in the transformer block 71. At the self-attention block 86, the computing device 10 is further configured to compute the query vector Q, the key matrix K, and the value vector V based at least in part on the RMS norm 74A of the embeddings 72. The computing device 10 is further configured to apply rotary positional encodings 76 to the query vector Q and the key matrix K. Using query vector Q, the key matrix K, and the value vector V, the computing device 10 is further configured to compute the self-attention 62 as discussed above.

The self-attention 62 may be a grouped multi-query attention. In addition, the computing device 10 may be configured to utilize a KV cache to store key tokens and value tokens from earlier in the input sequence. For example, the KV cache may be stored in the CSRAM 23 of the hardware accelerator 20. By using a KV cache, the hardware accelerator 20 may avoid recomputing previously computed self-attention scores.

Subsequently to the self-attention block 86, the computing device 10 is further configured to add the self-attention 62 to the embeddings 72 and compute an RMS norm 74B of the result. That RMS norm 74B is then input into a feed-forward block 88 that includes a plurality of feed-forward layers 78. Adjacent feed-forward layers 78 within the feed-forward block 88 are fully connected to each other.

The computing device 10 is further configured to add the output of the feed-forward block 88 to the sum of the embeddings 72 and the self-attention 62, and to compute an RMS norm 74C of that sum. The computing device 10 is further configured to input the RMS norm 74C into a linear layer 80. The computing device 10 is further configured to compute a SoftMax 82 of the output of the linear layer 80. In some examples, the SoftMax 82 is a Stable SoftMax, which may be computed as discussed above with reference to FIG. 3. The SoftMax 82 is the output of the transformer block 71.

Returning to FIG. 1, in some examples, the hardware accelerator 20 includes a plurality of the GEMV circuits 26 and a plurality of the post-processing circuits 30 that are configured to compute a respective plurality of the vector processing results 52 in parallel. The GEMV circuits 26 and the post-processing circuits 30 may be included in respective tiles 22 of the hardware accelerator. Using multiple GEMV circuits 26 and post-processing circuits 30 operating in parallel, those GEMV circuits 26 and post-processing circuits 30 may be used to perform GEMM operations. In some examples in which the input matrices to the GEMM operation have low height and/or width, performing the GEMM operation at the GEMV circuits 26 and the post-processing circuits 30 may be more efficient than performing the GEMM operation at the GEMM circuit 28.

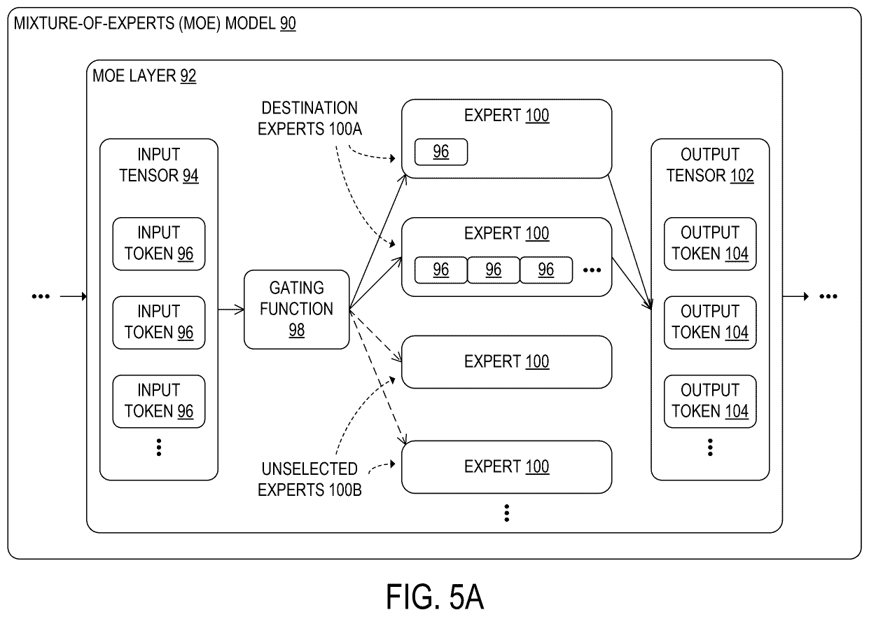

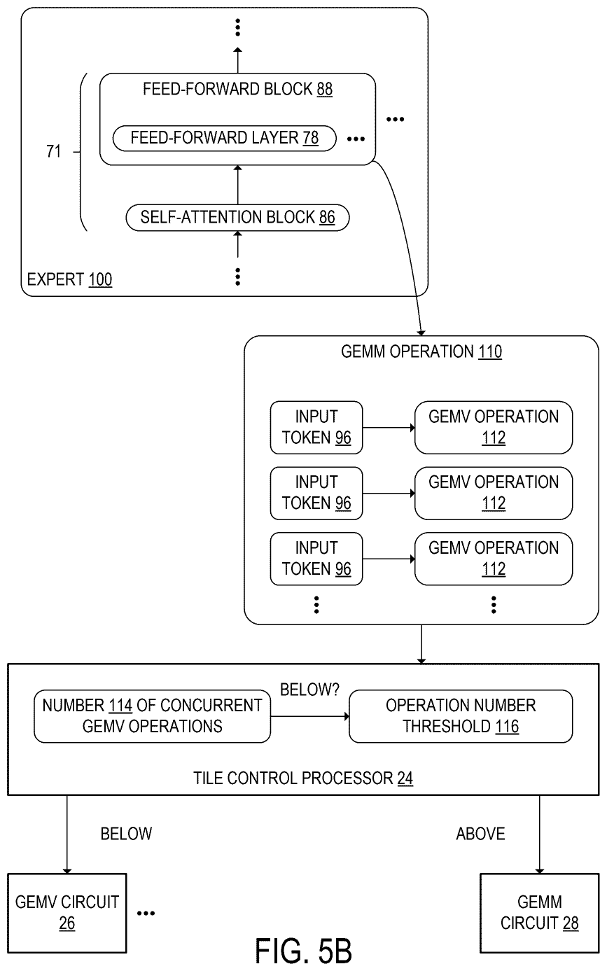

A GEMM operation may be performed at a plurality of GEMV circuits 26 and post-processing circuits 30 when executing a mixture-of-experts (MoE) model. An example MoE model 90 is schematically shown in FIG. 5A. The MoE model 90 includes at least one MoE layer 92. The MoE layer 92 is configured to receive an input tensor 94 including a plurality of input tokens 96. The input tokens 96 may be vectors in an embedding space. The computing device 10 is further configured to execute a gating function 98 that routes the input tokens 96 to respective experts 100. The experts 100 are sub-networks of the MoE layer 92 that each include respective weights. For example, the experts 100 may each include one or more transformer blocks 71. At the experts 100, the computing device 10 is configured to process the input tokens 96 to compute output tokens 104 and is further configured to output the output tokens 104 from the MoE layer 92 in an output tensor 102.

As shown in the example of FIG. 5A, the gating function 98 assigns different numbers of input tokens 96 to different experts 100. The MoE layer 92 includes one or more destination experts 100A that each receive one or more of the input tokens 96, as well as one or more unselected experts 100B that do not receive any of the input tokens 96. Different destination experts 100A may also receive different numbers of input tokens 96, as shown in the example of FIG. 5A.

FIG. 5B schematically shows an expert 100 that includes a transformer block 71. This transformer block includes a self-attention block 86 and a feed-forward block 88, as discussed above with reference to FIG. 4. At the feed-forward block 88, the hardware accelerator 20 is configured to perform a GEMM operation 110. This GEMM operation 110 includes one or more GEMV operations 112 performed on respective input tokens 96. A plurality of concurrent GEMV operations 112 are performed at a feed-forward layer 78 included in the expert 100 in the example of FIG. 5B.

At the TCP 24, according to the example of FIG. 5B, the hardware accelerator 20 is configured to receive an indication of a number 114 of concurrent GEMV operations 112 included in the GEMM operation 110. The number 114 of concurrent GEMV operations 112 is equal to the number of input tokens 96 routed to the expert 100. The TCP 24 may be further configured to determine that the number of concurrent GEMV operations 112 is below an operation number threshold 116. For example, the operation number threshold 116 may be three or four GEMV operations 112.

In response to determining that the number 114 of concurrent GEMV operations 112 is below the operation number threshold 116, the hardware accelerator 20 is configured to perform the GEMM operation 110 at the plurality of the GEMV circuits 26. If the TCP 24 instead determines that the number 114 of concurrent GEMV operations 112 included in the GEMM operation 110 is above the operation number threshold 116, the hardware accelerator 20 is instead configured to perform the GEMM operation 110 at the GEMM circuit 28. The TCP 24 may accordingly be configured to select the circuit at which performing the GEMM operation 110 is more efficient.

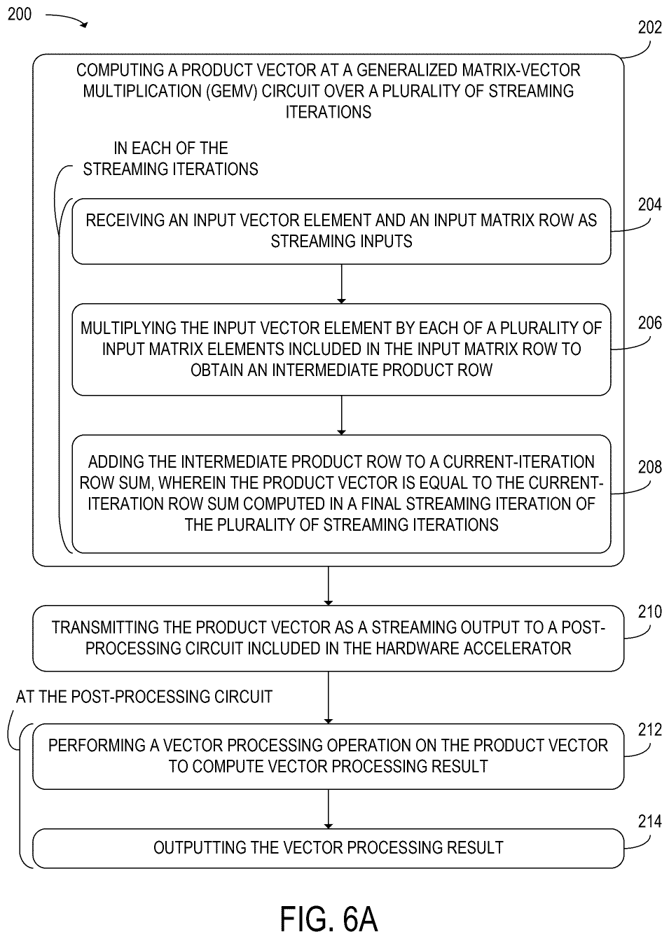

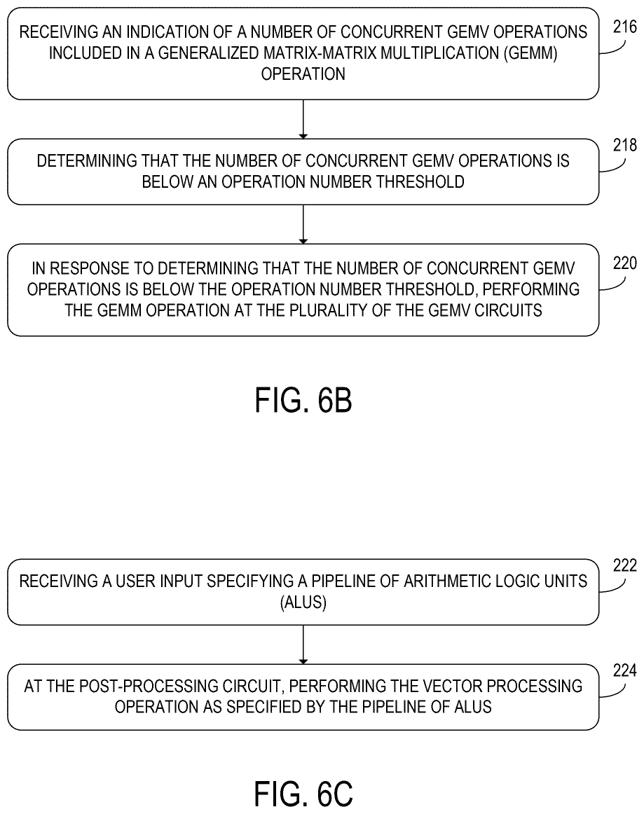

FIG. 6A shows a flowchart of a method 200 performed at a hardware accelerator included in a computing device. The hardware accelerator may, for example, be an NPU. The method 200 includes, at step 202, computing a product vector at a GEMV circuit over a plurality of streaming iterations. Each of the streaming iterations includes, at step 204, receiving an input vector element and an input matrix row as streaming inputs. In some examples, the input vector elements and the input matrix rows may be received at the GEMV circuit via DMA. The input vector element and the input matrix row are respectively included in an input vector and an input matrix. The input vector and the input matrix may be a query vector and a key matrix, respectively. In such examples, the product vector may be computed at a neural network during a self-attention computation.

Step 202 further includes, at step 206, multiplying the input vector element by each of a plurality of input matrix elements included in the input matrix row to obtain an intermediate product row. At step 208, step 202 further includes adding the intermediate product row to a current-iteration row sum. The product vector computed as the output of step 202 is equal to the current-iteration row sum computed in a final streaming iteration of the plurality of streaming iterations. By streaming the inputs and outputs of the GEMV circuit instead of loading the entire input vector and input matrix into buffers prior to processing, the efficiency of GEMV operations may be increased by increasing the utilization rate of the GEMV circuit.

At step 210, the method 200 further includes transmitting the product vector as a streaming output to a post-processing circuit included in the hardware accelerator. The method 200 further includes steps 212 and 214, which are performed at the post-processing circuit. At step 212, the method 200 further includes performing a vector processing operation on the product vector to compute vector processing result. At step 214, the method 200 further includes outputting the vector processing result.

The vector processing operation may be a maximum-finding operation, a minimum-finding operation, or a scaling operation. In examples in which the input vector is a query vector and the input matrix is a key matrix, the vector processing operation may be a maximum-finding operation included in a Stable SoftMax operation that is performed during the self-attention computation. The self-attention computation may be performed during training or inferencing at a neural network that has a transformer architecture.

FIG. 6B shows additional steps of the method 200 that may be performed in examples in which a respective plurality of the vector processing results are computed in parallel at a plurality of the GEMV circuits and a plurality of the post-processing circuits. The plurality of GEMV circuits and post-processing circuits may, for example, be included in separate tiles of the hardware accelerator. At step 216, the method 200 may further include receiving an indication of a number of concurrent GEMV operations included in a generalized matrix-matrix multiplication (GEMM) operation. In the example of FIG. 6B, the number of concurrent GEMV operations may be equal to a number of input tokens routed to an expert included in a mixture-of-experts (MoE) neural network. In such examples, the concurrent GEMV operations may be performed at a feed-forward layer included in the expert. Thus, the GEMV circuits may be used at a feed-forward block of the expert as well as at a self-attention block.

At step 218, the method may further include determining that the number of concurrent GEMV operations is below an operation number threshold. This determination may be made at a TCP included in the hardware accelerator. For example, the number threshold may be three or four GEMV operations. At step 220, in response to determining that the number of concurrent GEMV operations is below the operation number threshold, the method 200 may further include performing the GEMM operation at the plurality of the GEMV circuits. Thus, the GEMM operation may be performed at the GEMV circuits instead of at a GEMM circuit included in the hardware accelerator. The GEMM operation may be performed at the GEMV circuits in scenarios in which the number of concurrent GEMV operations is low enough that performing the GEMM operation at the GEMV circuits is more efficient.

FIG. 6C shows additional steps of the method 200 that may be performed in some examples. At step 222, the method 200 may further include receiving a user input specifying a pipeline of arithmetic logic units (ALUs). The ALUs are circuits that implement hardware-level logic gates and are selected by the user to define the vector processing operation. At step 224, the method 200 further includes, at the post-processing circuit, performing the vector processing operation as specified by the pipeline of ALUs. The post-processing circuit is therefore reprogrammable according to user input.

Using the devices and methods discussed above, GEMV operations and post-processing operations that follow the GEMV operations may be performed efficiently at a GEMV circuit and a post-processing circuit included in a hardware accelerator. The GEMV circuit and the post-processing circuit may, for example, be used to accelerate self-attention computation in a neural network. By streaming the inputs and the outputs of the GEMV circuit, the hardware accelerator may avoid idle time associated with loading the input vector and input matrix into memory prior to processing. The devices and methods discussed above may therefore increase the utilization rate of processing circuitry included in the GEMV circuit. With the above efficiency increases, GEMV operations may be performed at the GEMV circuit more quickly than at a conventional GEMM circuit.

The post-processing circuit included in the hardware accelerator may allow for further increases in vector processing efficiency. By including a programmable post-processing circuit, the hardware accelerator may post-process a product vector computed during the GEMV operation in a manner that can be flexibly modified depending on the processing task in which the GEMV operation is included. Accordingly, the hardware accelerator may also use the GEMV circuit to accelerate GEMM operations that include small numbers of GEMV operations, such as when executing a feed-forward layer of an expert included in an MoE model.

In some embodiments, the methods and processes described herein may be tied to a computing system of one or more computing devices. In particular, such methods and processes may be implemented as a computer-application program or service, an application-programming interface (API), a library, and/or other computer-program product.

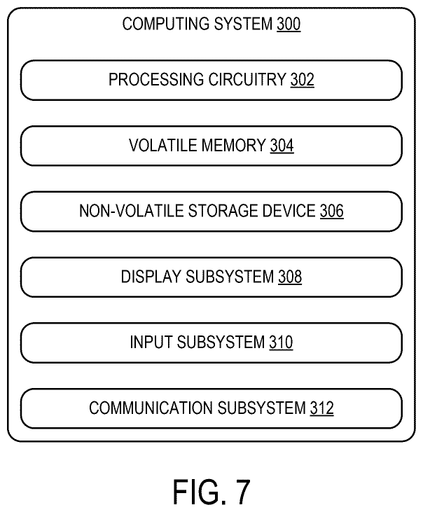

FIG. 7 schematically shows a non-limiting embodiment of a computing system 300 that can enact one or more of the methods and processes described above. Computing system 300 is shown in simplified form. Computing system 300 may embody the computing device 10 described above and illustrated in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 7.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a GUI. As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs discuss several aspects of the present disclosure. According to one aspect of the present disclosure, a computing device is provided, including a hardware accelerator. The hardware accelerator includes a generalized matrix-vector multiplication (GEMV) circuit configured to compute a product vector over a plurality of streaming iterations, wherein, at each of the streaming iterations, the GEMV circuit is configured to receive an input vector element and an input matrix row as streaming inputs. At each of the streaming iterations, the GEMV circuit is further configured to multiply the input vector element by each of a plurality of input matrix elements included in the input matrix row to obtain an intermediate product row. At each of the streaming iterations, the GEMV circuit is further configured to add the intermediate product row to a current-iteration row sum. The product vector is equal to the current-iteration row sum computed in a final streaming iteration of the plurality of streaming iterations. The GEMV circuit is further configured to transmit the product vector as a streaming output to a post-processing circuit included in the hardware accelerator. The post-processing circuit is configured to perform a vector processing operation on the product vector to compute vector processing result. The post-processing circuit is further configured to output the vector processing result. The above features may have the technical effect of efficiently performing, at the hardware level, both a GEMV operation and post-processing that follows the GEMV operation.

According to this aspect, the vector processing operation may be a maximum-finding operation, a minimum-finding operation, or a scaling operation. The above features may have the technical effect of post-processing the product vector using an operation that frequently occurs in a machine learning setting.

According to this aspect, the GEMV circuit may be configured to compute the product vector as a product of a query vector and a key matrix during a self-attention computation performed at a neural network. The above features may have the technical effect of efficiently performing the self-attention computation at the neural network.

According to this aspect, the vector processing operation may be the maximum-finding operation. The maximum-finding operation may be included in a Stable SoftMax operation performed during the self-attention computation. The above features may have the technical effect of efficiently performing the Stable SoftMax operation on the product of the query vector and the key matrix.

According to this aspect, the GEMV circuit is configured to receive the input vector elements and the input matrix rows via direct memory access (DMA). The above feature may have the technical effect of avoiding having to read the input vector and input matrix into TSRAM prior to processing.

According to this aspect, the hardware accelerator may include a plurality of the GEMV circuits and a plurality of the post-processing circuits that are configured to compute a respective plurality of the vector processing results in parallel. The above features may have the technical effect of reducing the amount of time consumed when computing the plurality of vector processing results.

According to this aspect, the hardware accelerator may further include a control processor configured to receive an indication of a number of concurrent GEMV operations included in a generalized matrix-matrix multiplication (GEMM) operation. The control processor may be further configured to determine that the number of concurrent GEMV operations is below an operation number threshold. In response to determining that the number of concurrent GEMV operations is below the operation number threshold, the control processor may be further configured to perform the GEMM operation at the plurality of the GEMV circuits. The above features may have the technical effect of utilizing the GEMV circuits to perform a GEMM operation in examples in which a dimension of a matrix used in the GEMM operation is low enough that the GEMM operation is more efficient to perform at the GEMV circuits.

According to this aspect, the number of concurrent GEMV operations may be equal to a number of input tokens routed to an expert included in a mixture-of-experts (MoE) neural network. The above feature may have the technical effect of utilizing the GEMV circuits to perform a GEMM operation at the expert when the number of routed tokens is low.

According to this aspect, the concurrent GEMV operations may be performed at a feed-forward layer included in the expert. The above feature may have the technical effect of executing the feed-forward layer more efficiently than it would be executed with a GEMM circuit.

According to this aspect, the post-processing circuit may be configured to execute the vector processing operation at a pipeline of arithmetic logic units (ALUs). The pipeline of ALUs may be specified via user input. The above features may have the technical effect of allowing the user to customize the vector processing operation performed at the post-processing circuit.

According to another aspect of the present disclosure, a method performed at a hardware accelerator included in a computing device is provided. The method includes computing a product vector at a generalized matrix-vector multiplication (GEMV) circuit over a plurality of streaming iterations. Each of the streaming iterations includes receiving an input vector element and an input matrix row as streaming inputs. Each of the streaming iterations further includes multiplying the input vector element by each of a plurality of input matrix elements included in the input matrix row to obtain an intermediate product row. Each of the streaming iterations further includes adding the intermediate product row to a current-iteration row sum. The product vector is equal to the current-iteration row sum computed in a final streaming iteration of the plurality of streaming iterations. The method further includes transmitting the product vector as a streaming output to a post-processing circuit included in the hardware accelerator. At the post-processing circuit, the method further includes performing a vector processing operation on the product vector to compute vector processing result. The method further includes outputting the vector processing result. The above features may have the technical effect of efficiently performing, at the hardware level, both a GEMV operation and post-processing that follows the GEMV operation.

According to this aspect, the vector processing operation may be a maximum-finding operation, a minimum-finding operation, or a scaling operation. The above features may have the technical effect of post-processing the product vector using an operation that frequently occurs in a machine learning setting.

According to this aspect, the product vector may be a product of a query vector and a key matrix and may be computed at a neural network during a self-attention computation. The above features may have the technical effect of efficiently performing the self-attention computation at the neural network.

According to this aspect, the vector processing operation may be the maximum-finding operation. The maximum-finding operation may be included in a Stable SoftMax operation performed during the self-attention computation. The above features may have the technical effect of efficiently performing the Stable SoftMax operation on the product of the query vector and the key matrix.

According to this aspect, the input vector elements and the input matrix rows may be received at the GEMV circuit via direct memory access (DMA). The above feature may have the technical effect of avoiding having to read the input vector and input matrix into TSRAM prior to processing.

According to this aspect, a respective plurality of the vector processing results may be computed in parallel at a plurality of the GEMV circuits and a plurality of the post-processing circuits. The method may further include receiving an indication of a number of concurrent GEMV operations included in a generalized matrix-matrix multiplication (GEMM) operation. The method may further include determining that the number of concurrent GEMV operations is below an operation number threshold. In response to determining that the number of concurrent GEMV operations is below the operation number threshold, the method may further include performing the GEMM operation at the plurality of the GEMV circuits. The above features may have the technical effect of utilizing the GEMV circuits to perform a GEMM operation in examples in which a dimension of a matrix used in the GEMM operation is low enough that the GEMM operation is more efficient to perform at the GEMV circuits.

According to this aspect, the number of concurrent GEMV operations may be equal to a number of input tokens routed to an expert included in a mixture-of-experts (MoE) neural network. The above feature may have the technical effect of utilizing the GEMV circuits to perform a GEMM operation at the expert when the number of routed tokens is low.

According to this aspect, the concurrent GEMV operations may be performed at a feed-forward layer included in the expert. The above feature may have the technical effect of executing the feed-forward layer more efficiently than it would be executed with a GEMM circuit.

According to this aspect, the method may further include receiving a user input specifying a pipeline of arithmetic logic units (ALUs). At the post-processing circuit, the method may further include performing the vector processing operation as specified by the pipeline of ALUs. The above features may have the technical effect of allowing the user to customize the vector processing operation performed at the post-processing circuit.

According to another aspect of the present disclosure, a computing device is provided, including a hardware accelerator. The hardware accelerator includes a generalized matrix-vector multiplication (GEMV) circuit configured to receive a query vector and a key matrix. The GEMV circuit is further configured to multiply the query vector by the key matrix to compute a product vector. The GEMV circuit is further configured to output the product vector to a post-processing circuit included in the hardware accelerator. The post-processing circuit is configured to identify a maximum element of the product vector and transmit the maximum element to a tile vector processor (TVP) included in the hardware accelerator. The TVP is configured to compute a Stable SoftMax of the product vector using the maximum element. The TVP is further configured to transmit the Stable SoftMax to the GEMV circuit. The GEMV circuit is further configured to multiply the Stable SoftMax by a value vector to compute a self-attention. The GEMV circuit is further configured to output the self-attention. The above features may have the technical effect of efficiently performing self-attention computation at a neural network.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device comprising:
a hardware accelerator including:
a generalized matrix-vector multiplication (GEMV) circuit configured to:
compute a product vector over a plurality of streaming iterations, wherein, at each of the streaming iterations, the GEMV circuit is configured to:
receive an input vector element and an input matrix row as streaming inputs;
multiply the input vector element by each of a plurality of input matrix elements included in the input matrix row to obtain an intermediate product row; and
add the intermediate product row to a current-iteration row sum, wherein the product vector is equal to the current-iteration row sum computed in a final streaming iteration of the plurality of streaming iterations; and
transmit the product vector as a streaming output to a post-processing circuit included in the hardware accelerator,
wherein the post-processing circuit is configured to:
perform a vector processing operation on the product vector to compute vector processing result; and
output the vector processing result.

2. The computing device of claim 1, wherein the vector processing operation is a maximum-finding operation, a minimum-finding operation, or a scaling operation.

3. The computing device of claim 2, wherein the GEMV circuit is configured to compute the product vector as a product of a query vector and a key matrix during a self-attention computation performed at a neural network.

4. The computing device of claim 3, wherein:
the vector processing operation is the maximum-finding operation; and
the maximum-finding operation is included in a Stable SoftMax operation performed during the self-attention computation.

5. The computing device of claim 1, wherein the GEMV circuit is configured to receive the input vector elements and the input matrix rows via direct memory access (DMA).

6. The computing device of claim 1, wherein the hardware accelerator includes a plurality of the GEMV circuits and a plurality of the post-processing circuits that are configured to compute a respective plurality of the vector processing results in parallel.

7. The computing device of claim 6, wherein the hardware accelerator further includes a control processor configured to:
receive an indication of a number of concurrent GEMV operations included in a generalized matrix-matrix multiplication (GEMM) operation;
determine that the number of concurrent GEMV operations is below an operation number threshold; and
in response to determining that the number of concurrent GEMV operations is below the operation number threshold, perform the GEMM operation at the plurality of the GEMV circuits.

8. The computing device of claim 7, wherein the number of concurrent GEMV operations is equal to a number of input tokens routed to an expert included in a mixture-of-experts (MoE) neural network.

9. The computing device of claim 8, wherein the concurrent GEMV operations are performed at a feed-forward layer included in the expert.

10. The computing device of claim 1, wherein:
the post-processing circuit is configured to execute the vector processing operation at a pipeline of arithmetic logic units (ALUs); and
the pipeline of ALUs is specified via user input.

11. A method performed at a hardware accelerator included in a computing device, the method comprising:
computing a product vector at a generalized matrix-vector multiplication (GEMV) circuit over a plurality of streaming iterations, wherein each of the streaming iterations includes:
receiving an input vector element and an input matrix row as streaming inputs;
multiplying the input vector element by each of a plurality of input matrix elements included in the input matrix row to obtain an intermediate product row; and
adding the intermediate product row to a current-iteration row sum, wherein the product vector is equal to the current-iteration row sum computed in a final streaming iteration of the plurality of streaming iterations;
transmitting the product vector as a streaming output to a post-processing circuit included in the hardware accelerator; and
at the post-processing circuit:
performing a vector processing operation on the product vector to compute vector processing result; and
outputting the vector processing result.

12. The method of claim 11, wherein the vector processing operation is a maximum-finding operation, a minimum-finding operation, or a scaling operation.

13. The method of claim 12, wherein the product vector is a product of a query vector and a key matrix and is computed at a neural network during a self-attention computation.

14. The method of claim 13, wherein:
the vector processing operation is the maximum-finding operation; and
the maximum-finding operation is included in a Stable SoftMax operation performed during the self-attention computation.

15. The method of claim 11, wherein the input vector elements and the input matrix rows are received at the GEMV circuit via direct memory access (DMA).

16. The method of claim 11, wherein:
a respective plurality of the vector processing results are computed in parallel at a plurality of the GEMV circuits and a plurality of the post-processing circuits; and
the method further comprises:
receiving an indication of a number of concurrent GEMV operations included in a generalized matrix-matrix multiplication (GEMM) operation;
determining that the number of concurrent GEMV operations is below an operation number threshold; and
in response to determining that the number of concurrent GEMV operations is below the operation number threshold, performing the GEMM operation at the plurality of the GEMV circuits.

17. The method of claim 16, wherein the number of concurrent GEMV operations is equal to a number of input tokens routed to an expert included in a mixture-of-experts (MoE) neural network.

18. The method of claim 17, wherein the concurrent GEMV operations are performed at a feed-forward layer included in the expert.

19. The method of claim 11, further comprising:
receiving a user input specifying a pipeline of arithmetic logic units (ALUs); and
at the post-processing circuit, performing the vector processing operation as specified by the pipeline of ALUs.

20. A computing device comprising:
a hardware accelerator including:
a generalized matrix-vector multiplication (GEMV) circuit configured to:
receive a query vector and a key matrix;
multiply the query vector by the key matrix to compute a product vector; and
output the product vector to a post-processing circuit included in the hardware accelerator,
wherein the post-processing circuit is configured to:
identify a maximum element of the product vector; and
transmit the maximum element to a tile vector processor (TVP) included in the hardware accelerator,
wherein the TVP is configured to:
compute a Stable SoftMax of the product vector using the maximum element; and
transmit the Stable SoftMax to the GEMV circuit,
wherein the GEMV circuit is further configured to:
multiply the Stable SoftMax by a value vector to compute a self-attention; and
output the self-attention.
